(19) United States
(12) Patent Application Publication
(10) Pub. No.: US 2017/0286522 A1
(43) Pub. Date: Oct. 5, 2017

(54) DATA FILE GROUPING ANALYSIS

(71) Applicant: SHUTTERSTOCK, INC., New York, NY (US)

(72) Inventors: Heath HOHWALD, Logroño (ES); Kevin Scott LESTER, Summit, NJ (US); Manor LEV-TOV, Brooklyn, NY (US); Xinyu LI, Jersey City, NJ (US)

(21) Appl. No.: 15/090,001

(22) Filed: Apr. 4, 2016

(51) Int. Cl. G06F 17/30

(52) U.S. Cl. CPC G06F 17/30598; G06F 17/30029; G06F 17/3005

(57) ABSTRACT

Methods for analyzing data files to identify similar files to group for display within a limited visual space of a graphical user interface are provided. In one aspect, a method includes receiving a search query for a collection of media files, and identifying a subset of the media files from the collection that is responsive to the search query. The method also includes grouping the subset of the media files into a plurality of groups based on their visual similarity, wherein the visual similarity of each media file in the subset of media files is determined using an image vector corresponding to each media file, and providing the subset of the media files for display in their respective groups. Systems and machine-readable media are also provided.

### BACKGROUND

### Field

The present disclosure generally relates to analyzing image vector data corresponding data files to determine data file similarity.

### Description of the Related Art

Network accessible data file repositories for content commonly hosted on server devices ordinarily provide users of client devices with the ability to access search algorithms for searching and accessing data files for content in the data file repositories. For example, for a network accessible media content repository with a large volume of data files, such as for images and videos, a user that seeks to search for media related to cats may enter the search query “cats” into a search interface for the online image content repository accessible by and displayed on the user's client device. Media associated with the keyword “cat” or “cats” that is determined by the server to be responsive to the search query may then be returned to the client device for display to the user. There are often, however, a large number of media files that are valid results for a common query such as “cats”. These media files are commonly displayed as individual files, requiring significant time to view by the user within the limited amount of visual space of a client device's display screen.

### SUMMARY

The disclosed system identifies media files from a collection of media files that are responsive to a search query from a user, and analyzes image vector data corresponding to those media files to determine a visual similarity between the media files in order to group the media files based on their visual similarity. The media files responsive to the search query are then presented to the user grouped according to their visual similarity so that the user can view a greater diversity of media files within the limited amount of visual space of a display screen, narrowing the user's focus more quickly to media files of interest to the user, and permitting the user to more quickly explore the media files of interest once the user has found media files of interest by allowing the user to select the group of media files of interest to the user.

According to certain aspects of the present disclosure, a computer-implemented method for analyzing data files to identify similar files to group for display within a limited visual space of a graphical user interface is provided. The method includes receiving a search query for a collection of media files, and identifying a subset of the media files from the collection that is responsive to the search query. The method also includes grouping the subset of the media files into a plurality of groups based on their visual similarity, wherein the visual similarity of each media file in the subset of media files is determined using an image vector corresponding to each media file, and providing the subset of the media files for display in their respective groups.

According to certain aspects of the present disclosure, a system for analyzing data files to identify similar files to group for display within a limited visual space of a graphical user interface is provided. The system includes a memory that includes instructions, and a processor. The processor is configured to execute the instructions to receive a search query for a collection of media files, each media file in the collection of media files having an associated unique index value mapping each media file to a corresponding dense image vector for the media file capturing the visual nature of the media file, and identify a subset of the media files from the collection that is responsive to the search query. The processor is also configured to execute the instructions to group the subset of the media files into a plurality of groups based on their visual similarity, wherein the visual similarity of each media file in the subset of media files is determined using an image vector corresponding to each media file, and provide the subset of the media files for display in their respective groups.

According to certain aspects of the present disclosure, a non-transitory machine-readable storage medium includes machine-readable instructions for causing a processor to execute a method for analyzing data files to identify similar files to group for display within a limited visual space of a graphical user interface is provided. The method includes receiving a search query for a collection of media files, each media file in the collection of media files having an associated unique index value mapping each media file to a corresponding dense image vector for the media file capturing the visual nature of the media file, and identifying a subset of the media files from the collection that is responsive to the search query. The method also includes clustering the subset of the media files into predetermined number of groups based on their visual similarity using a k means clustering algorithm by applying a cosine similarity algorithm to the dense image vectors corresponding to the subset of media files, and providing the subset of the media files for display in their respective groups ordered according to a responsiveness value to the search query of the most responsive media file in the respective group, or ordered according to an average of the responsiveness values to the search query of each of the media files in the respective group. Providing the subset of the media files for display in their respective groups includes, for each group to be displayed, displaying a first media file in the group at a first size, and displaying at least one other file in the group at a second size smaller than the first size, or for each media file in a group to be displayed, displaying each of the displayed media files in the group at equal sizes, and for media files not displayed in a displayed group of media files, providing an interface for a user to select additional media files from the displayed group to be displayed.

According to certain aspects of the present disclosure, a system for analyzing data files to identify similar files to group for display within a limited visual space of a graphical user interface is provided. The system includes means for receiving a search query for a collection of media files, and means for identifying a subset of the media files from the collection that is responsive to the search query. The means for identifying is also configured to group the subset of the media files into a plurality of groups based on their visual similarity, wherein the visual similarity of each media file in the subset of media files is determined using an image vector corresponding to each media file. The means for receiving is also configured to provide the subset of the media files for display in their respective groups.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for analyzing data files to identify similar files to group for display within a limited visual space of a graphical user interface.

FIG. 2 is a block diagram illustrating an example server from the architecture of FIG. 1 according to certain aspects of the disclosure.

FIG. 3 illustrates an example process for analyzing data files to identify similar files to group for display within a limited visual space of a graphical user interface using the example server of FIG. 2.

FIGS. 4A and 4B are example illustrations associated with the example process of FIG. 3 illustrating providing media files responsive to search queries for display that are grouped to display within a limited visual space for a graphical user interface according to visual similarity in their respective groups.

FIG. 5 is a block diagram illustrating an example computer system with which the server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system addresses a technical problem tied to computer technology of being unable to provide what is commonly very many media files responsive to a user's search query within the limited amount of display space of the user's device. The disclosed system also addresses a technical problem of providing media files that are too similar to one another due to a searching algorithm in response to the user's search query such that the user does not see sufficient diversity in the user's search results.

The disclosed system addresses these technical problems tied to computer technology and specifically arising in graphical user interfaces through the technical solution of using image vector data analysis and various computer algorithms to identify data file similarity for data files responsive to a search query, and thereafter grouping together the data files based on their visual similarity to efficiently use limited graphical user interface visual space of a display device. Specifically, the disclosed system provides for grouping together visually similar media files that are responsive to a search query to a collection of media files through the analysis of image vector data corresponding to the responsive media files to identify visual similarity. As a result, instead of providing individual media files in response to the search query, the groups of visually similar media files are the search results for the search query, where each group of visually similar media files is an ordered list of sets of visually similar media files. The groupings may be formed in real time after both a search query is received and results responsive to the search query are identified using various approaches, including using a k means clustering algorithm to cluster together the groups of visually similar media files, or using thresholding to create the groups of visually similar media files.

The disclosed technical solution results in many improvements to the technologies of search algorithm result categorization and graphical user interfaces content display optimization, particularly in the useful application of visual media file search and result display. For example, one improvement is that a greater diversity of media file search results is presented to a user because of the limit of how many visual media files can be displayed in the limited visual space of a display device. Another example improvement is that a user is more quickly able to find a media file search result responsive to the user's search query because the user is more quickly able to narrow the user's attention to a subset of the media file search results that is visually responsive to the user's desired search result without requiring that the user view or otherwise be shown every media file on a graphical user interface search result screen (e.g., search result web page).

Yet another example improvement is that the user can more easily explore a relevant subspace of the media file search results that the user is interested in because the user can interact with the graphical user interface for the search results to indicate the user is interested in a particular subset of media files in order to view more visually similar media files from the subset. Yet a further example improvement is that processing capacity and memory storage, and thereby power consumption, of the client device is improved by providing a greater diversity of images for display to a user on the client device within a single display screen. As a result, less rendering occurs and fewer screens are needed for displaying the media file search results, thereby requiring less user of the client device's processing and memory resources, which results in less power consumption by the client device. Yet another example improvement is that newer media files with limited or no user behavior data can be integrated into media file search results to facilitate the obtaining of user behavior data for those media files. For example, for a group of “cat” images, newer cat images that have very few views by users can be included in a group of visually similar images presented to a user in response to an image search query for “cats”. The number of newer media files can be limited to a certain percentage of images in a visually similar group in order to allow newer media files to get viewed and increase recall associated with the collection of media files from which they are selected.

While many examples are provided herein in the context of providing media files (e.g., image files, video files, visual multimedia files) for display that are responsive to a search query, the principles of the present disclosure contemplate other types of contexts for providing multiple media files for display. For example, multiple media files may be provided for display within a limited visual space of a display device when a user seeks to view multiple images stored on a device (e.g., viewing photos in a file directory on the device).

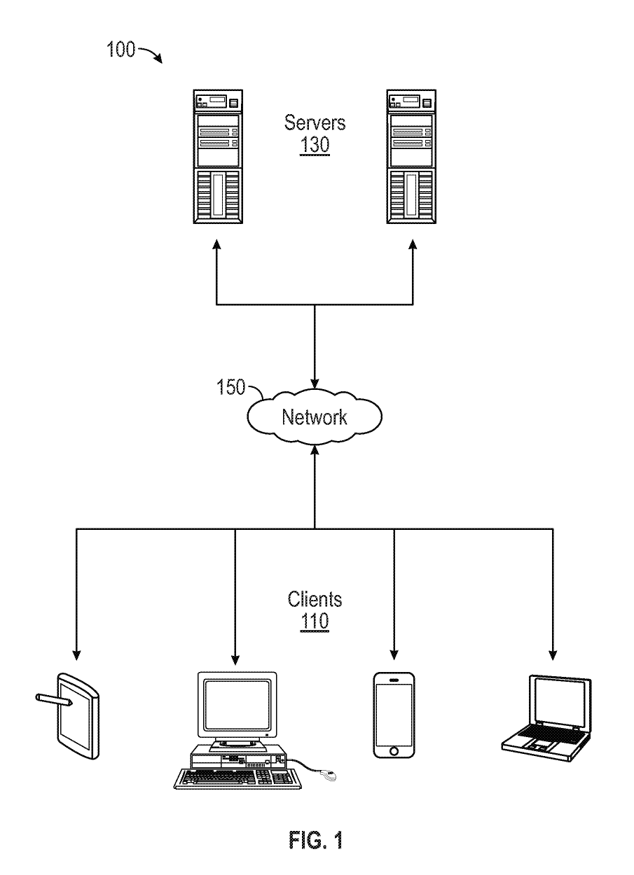

Turning to the drawings, FIG. 1 illustrates an example architecture 100 for analyzing data files to identify similar files to group for display within a limited visual space of a graphical user interface. The architecture 100 includes servers 130 and clients 110 connected over a network 150.

One of the many servers 130 is configured to host a media file similarity grouping algorithm and a collection of media files. The collection of media files includes, for each media file, an image vector corresponding to the media file. For purposes of load balancing, multiple servers 130 can host the collection of media files and the media file similarity grouping algorithm.

The disclosed system provides for the grouping of visually similar media files in image search results responsive to a search query in order to provide a greater diversity (e.g., of visually dissimilar) media files responsive to the search query within a limited visual space to display to a user. Specifically, in response to a server 130 receiving a query of a collection of media files from a client 110, the server 130 returns an identification (e.g., an ordered list of media file identifiers) of media files that are responsive to the query, and image vectors corresponding to the identified media files are processed for visual similarity and grouped according to a threshold visual similarity value. The media files can be processed for visual similarity and grouped using a clustering algorithm, such as, but not limited to, a k means clustering algorithm. Alternatively, the media files can be processed for visual similarity and grouped using thresholding. The media files responsive to the query are then provided to the client 110 for display in groups according to their visual similarity.

The servers 130 can be any device having an appropriate processor, memory, and communications capability for hosting the media file similarity grouping algorithm and the collection of media files. The clients 110 to which the servers 130 are connected over the network 150 can be, for example, desktop computers, mobile computers, tablet computers (e.g., including e-book readers), mobile devices (e.g., a smartphone or PDA), or any other devices having appropriate processor, memory, and communications capabilities. The network 150 can include, for example, any one or more of a local area network (LAN), a wide area network (WAN), the Internet, and the like. Further, the network 150 can include, but is not limited to, any one or more of the following network topologies, including a bus network, a star network, a ring network, a mesh network, a star-bus network, tree or hierarchical network, and the like.

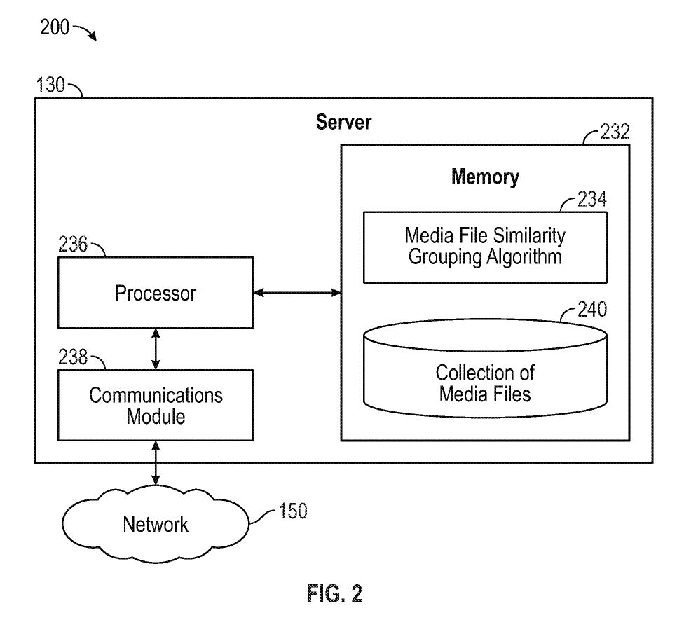

FIG. 2 is a block diagram 200 illustrating an example server 130 in the architecture 100 of FIG. 1 according to certain aspects of the disclosure. The server 130 is connected over the network 150 via a communications module 238. The communications module 238 is configured to interface with the network 150 to send and receive information, such as data, requests (e.g., search queries for a collection of media files 240), responses (e.g., an identification of media files from the collection of media files 240 responsive to search queries), and commands to other devices (e.g., clients 110) on the network 150. The communications module 238 can be, for example, a modem or Ethernet card.

The server 130 includes a processor 236, a communications module 238, and a memory 232 that includes a media file similarity grouping algorithm 234 and the collection of media files 240.

The collection of media files 240 includes files such as images, video recordings with or without audio, visual multimedia (e.g., slideshows). In certain aspects the collection of media files 240 also includes a dense vector for each media file in the collection of media files 240, and each media file in the collection of media files 240 is mapped to its corresponding dense vector representation using a unique index value (or “identifier”) for the media file that is listed in an index. The dense vector representation of a media file (e.g., a 256 dimensional vector) captures the visual nature of the corresponding media file (e.g., of a corresponding image). The dense vector representation of a media file is such that, for example, given a pair of dense vector representations for a corresponding pair of images, similarity calculations, such as by using a cosine similarity algorithm, can meaningfully capture a visual similarity between the images. In certain aspects, each dense image vector can be normalized prior to later processing, e.g., prior to applying the cosine similarity algorithm to each dense image vector in order to expedite such later processing.

A convolutional neural network can be used to train a model to generate dense vector representations for media files, such as for images, and map each media file to its corresponding dense vector representation in a dense vector space. The convolutional neural network can be a type of feed-forward artificial neural network where individual neurons are tiled in such a way that the individual neurons respond to overlapping regions in a visual field. The architecture of the convolutional neural network may be in the style of existing well-known image classification architectures such as AlexNet, GoogLeNet, or Visual Geometry Group models. In certain aspects, the convolutional neural network consists of a stack of convolutional layers followed by several fully connected layers. The convolutional neural network can include a loss layer (e.g., softmax or hinge loss layer) to back propagate errors so that the convolutional neural network learns and adjusts its weights to better fit provided image data.

The processor 236 of the server 130 is configured to execute instructions, such as instructions physically coded into the processor 236, instructions received from software in memory 240, or a combination of both. For example, the processor 236 of the server 130 executes instructions to receive (e.g., from a client 110 over the network 150) a search query for the collection of media files 240, and identify a subset of the media files from the collection of media files 240 that is responsive to the search query. The processor 236 also executes instructions to group the subset of the media files into a plurality of groups based on their visual similarity.

The visual similarity of each media file in the subset of media files is determined using the image vector corresponding to each media file. Specifically, visual similarity of media files may be assessed by the media file similarity grouping algorithm 234 in order to group the subset of the media files using a k means clustering algorithm, thresholding, or other approaches such as affinity propagation clustering, agglomerative clustering, Birch clustering, density-based spatial clustering of applications with noise (DBSCAN), feature agglomeration, mini-batch k means clustering, mean shift clustering using a flat kernel, or spectral clustering.

According to certain aspects of the media file similarity grouping algorithm 234, in order to assess visual similarity to group identifiers for the subset of the media files from the collection that is responsive to the search query into an ordered groups of sets, a k means clustering algorithm is used to group the subset of the media files into a predetermined number of the clusters. The value of k can be adjusted based on the search query that is submitted in order to optimize cluster sizing, and the value can be learned by the media file similarity grouping algorithm 234 over time as more search queries are submitted through active learning.

In certain aspects, application of the k means clustering algorithm can include applying a cosine similarity algorithm to the dense image vectors corresponding to the subset of media files. As noted above, in certain aspects, each of the dense image vectors can be normalized prior to applying the cosine similarity algorithm to each of the dense image vectors.

According to certain other aspects of the media file similarity grouping algorithm 234, in order to assess visual similarity to group identifiers for the subset of the media files from the collection that is responsive to the search query into an ordered groups of sets, thresholding is used to group the subset of the media files into the plurality of groups. Thresholding includes assigning a first media file from the subset of media files to a cluster for the first media file, and for each of the remaining media files in the subset of media files calculating a distance between the corresponding media file and an existing cluster centroid, and if the calculated distance is greater than a predefined threshold, adding the corresponding media file to the existing cluster centroid, otherwise adding the corresponding media file to a new cluster centroid.

By way of example, an exemplary thresholding approach for a given ordered list L containing N media files, can include the first step of assigning media file 1 to its own cluster. For the second step, starting from media file 2, for each media file i: (a) calculate distances between i and each existing cluster centroid (cluster centroid is calculated as the mean of the dense image vectors), and (b) if maximum distance from (a) is greater than a predefined threshold, add media file i to the cluster associated with the maximum distance, else add media file i to its own cluster.

The predefined threshold value can be configured by a user as a heuristic approach to balance accuracy and speed for grouping the subset of media files that is responsive to the search query. For example, for a threshold value t=0.2, the value t can be used to filter out which pair of images are considered sufficiently similar to be considered for the same set. An exemplary algorithm to achieve this result can include, for example, starting with the above-referenced ordered list L of N media files, iterating through L and considering each media file i in turn while also create a list S of sets that is initially an empty list. For each media file i, look through the existing sets S and determine if i has cosine similarity less than or equal to threshold value t with any of the media files in each of the sets s in S. If i has cosine similarity less than or equal to threshold value t with any of the media files in a set s in S, then add media file i to the set s. If not, create a new set and add it to the list of sets S.

In certain aspects, in addition to processing the entire visual space of a media file (e.g., an entire image) from the collection of media files 240, the media file similarity grouping algorithm 234 can also process portions of visual spaces of a media file (e.g., a crop or portion of an image) for assessing visual similarity between media files or portions of media files. In certain aspects, the portion of the media file used in the visual similarity analysis can be previously identified by a user (e.g., where a user previously cropped a portion of an image), a feature extractor of a trained computer-operated neural network. In these aspects, a group of visually similar media files can include the same media multiple times, but identify different portions of the same media file as visually similar enough to one another to be included in the same group.

The processor 236 further executes instructions to provide the subset of the media files for display (e.g., on a client 110) in their respective groups. For example, each group of media files to be displayed can be displayed on a client 110 (e.g., in a web browser) by displaying a first media file in the group at a first size, and displaying at least one other file in the group at a second size smaller than the first size. Specifically, where the media files are images, for each group of images responsive to the search query to be displayed on a client 110, each group can be shown in a left to right and top to bottom fashion, and each group is shown with one large thumbnail of a representative image for the group and several other smaller thumbnails for other images from the group. To choose the representative image for the group, the first image in the original ordering (e.g., the image deemed most relevant to the search query) of the images can be chosen. The smaller thumbnails can be chosen in similar order and can be chosen to maximize the diversity of the group in the sense of total distance summed over the similarity score from each thumbnail to the representative image for the group.

As another example, each group of media files to be displayed can be displayed on a client 110 (e.g., in a mobile app) by displaying each of the displayed media files in the group at equal sizes. For example, if the media files are images, then the top n (e.g., four) most relevant images can be displayed in a grid of thumbnails of equal size. For media files not displayed in a displayed group, an interface can be provided (e.g., a clickable link or button) for a user to select additional media files from the displayed group to be displayed. For instance, where the media files are images, a user can click through to a particular image or to a link (e.g., “More like this” link) associated with each group to see more images in the particular group. If the user clicks on the link, all images in the top N results that belong to that group of images can be presented on a new web page. In certain aspects, only the representative media file for a group is displayed in the results for a search query, and other media files in the group are displayed when a user interacts with (e.g., hovers over) the representative media file when displayed in the results for the search query.

In certain aspects, each of the respective groups that is displayed is ordered according to a responsiveness value to the search query of the most responsive media file in the respective group. For example, if a certain group of media files responsive to a search query includes an image file that is determined to be most relevant to the search query, then that group of media files is displayed first or otherwise most prominently in response to the search query. Specifically, for instance, the processor 236 according to instructions from the media file similarity grouping algorithm 234 may iterate through the original media file list identifying media files responsive to the search query, and if the next media file belongs to a set that is not yet in the output ordered list of sets (e.g., to be displayed to a user), then the set to which the media file belongs is identified as the next set in the output ordered list. If the next media file belongs to a set that is already in the output ordered list, then no action is taken with respect to that media file and the process moves on to the next media file responsive to the search query.

In certain aspects, each of the respective groups that is displayed is ordered according to an average of the responsiveness values to the search query of each of the media files in the respective group. For example, if a first group of media files responsive to a search query consisted of three image files having a responsiveness to the search query of 70%, 75%, and 80%, respectively, which is a total average responsiveness for the first group of 75%, and a second group of media files responsive to the search query consisted of four image files having a responsiveness to the search query of 80%, 85%, 90%, and 95%, which is a total average responsiveness for the second group of 87.5%, then the second group of media files is displayed first or otherwise most prominently in response to the search query as compared to the first group of media files.

In certain aspects, each of the respective groups that is displayed is ordered according to a marketability (e.g., likelihood of download, past average download rate) of at least one of the media files in the respective group. For example, each of the respective groups that is displayed is ordered according to a marketability score of the most marketable media file in the respective group, or an average marketability score of the media files in the respective group, with the marketability score for a media file being based on, for example, a likelihood of interaction of a user with the media file and/or past interaction of users with similar media files. The marketability score of a media file can also be used to choose the representative media files for a group, e.g., the media file with the highest marketability score can be designated as the representative media file for a group.

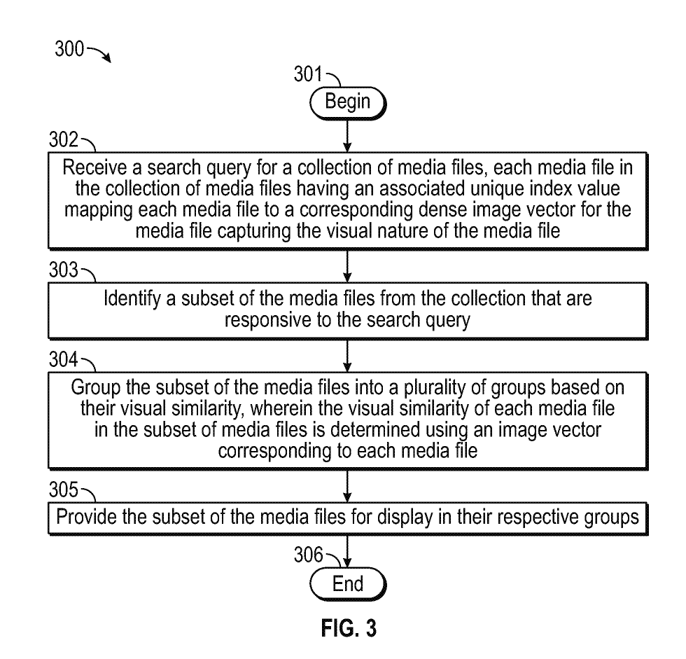

FIG. 3 illustrates an example process 300 for analyzing data files to identify similar files to group for display within a limited visual space of a graphical user interface using the example server of FIG. 2. While FIG. 3 is described with reference to FIG. 2, it should be noted that the process steps of FIG. 3 may be performed by other systems.

The process 300 begins by proceeding from beginning step 301 to step 302 when a search query for the collection of media files 240 is received. As discussed above, each media file in the collection of media files 240 has an associated unique index value mapping each media file to a corresponding dense image vector for the media file capturing the visual nature of the media file. Next, in step 303, a subset of the media files from the collection 240 that is responsive to the search query is identified, and in step 304 the subset of the media files is grouped into a plurality of groups based on their visual similarity. The visual similarity of each media file in the subset of media files from the collection 240 that is responsive to the search query is determined using an image vector corresponding to each media file. After providing the subset of the media files for display in their respective groups in step 305, the process 300 ends in step 306.

FIG. 3 set forth an example process 300 for analyzing data files to identify similar files to group for display within a limited visual space of a graphical user interface using the example server of FIG. 2. An example will now be described using the example process 300 of FIG. 3, a search query for “beer”, and media files that are images responsive to the search query “beer”.

The process 300 begins by proceeding from beginning step 301 to step 302 when a search query “beer” for images from the collection of media files 240 entered by a user in an application (e.g., a web page interface for searching the collection of media files 240 displayed in a web browser) on a mobile client 110 is received by the server 130.

Optionally, prior to receiving the search request, during a precomputation phase, each image in the collection of media files 240 is mapped to a dense image vector capturing the visual nature of the image. An index is also created prior to receiving the search request that maps each multimedia item in the collection 240, including each image, to its dense vector representation using a unique value/identifier associated with each multimedia item, and this index is exposed to the runtime system (e.g., accessible by the media file similarity grouping algorithm 234.

The search query “beer” is passed to the information retrieval backend, the media file similarity grouping algorithm 234, which in step 303 processes the search query and returns, a subset of the media files from the collection 240, namely an ordered list of identifiers of the most relevant images for the search query. The ordered list of identifiers is limited to a top threshold number of results (e.g., threshold N=500) because the full list of matching items for a search query can negatively impact performance and relevance.

In step 304 the ordered list of identifiers responsive to the search query “beer” is divided into groups based on the visual similarity of the images corresponding to the identifiers. Specifically, the media file similarity grouping algorithm 234 on the server 130 uses the identifiers of the most relevant images for the search query to retrieve the corresponding dense image vectors of those images. Thereafter, the media file similarity grouping algorithm 234 on the server 130 applies a k means clustering algorithm, where the number of groups k=10, to cluster the images into ten clusters, where each cluster represents a set of visually similar images. Visual similarity for the k means clustering algorithm is determined by using a similarity measure, such as cosine similarity, to measure similarity between the dense image vectors corresponding to the images responsive to the search query “beer”.

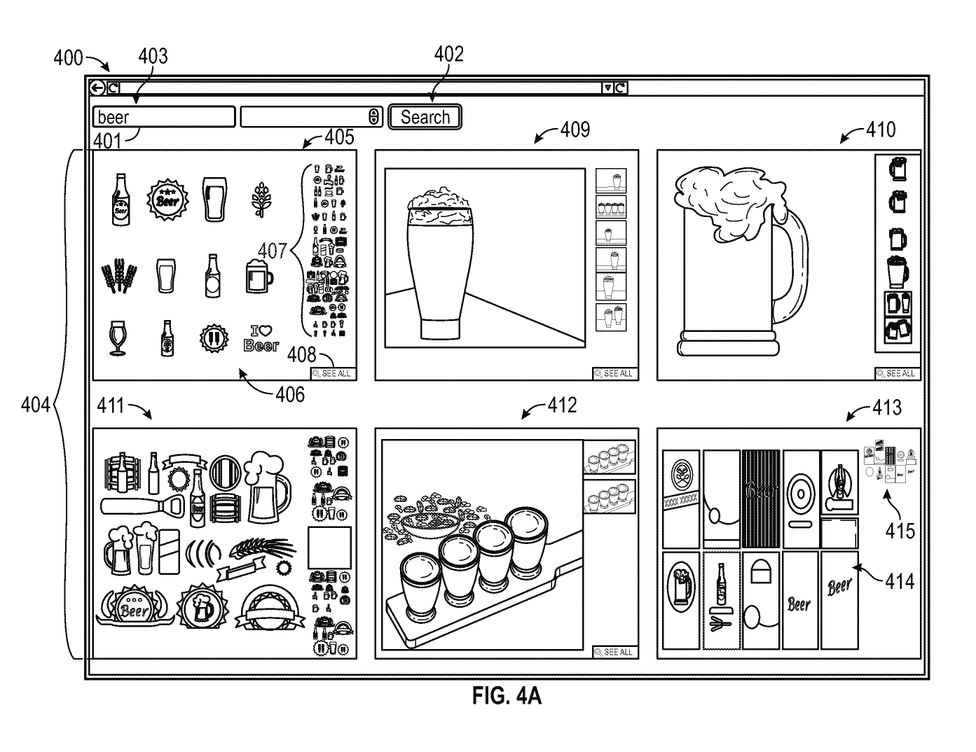

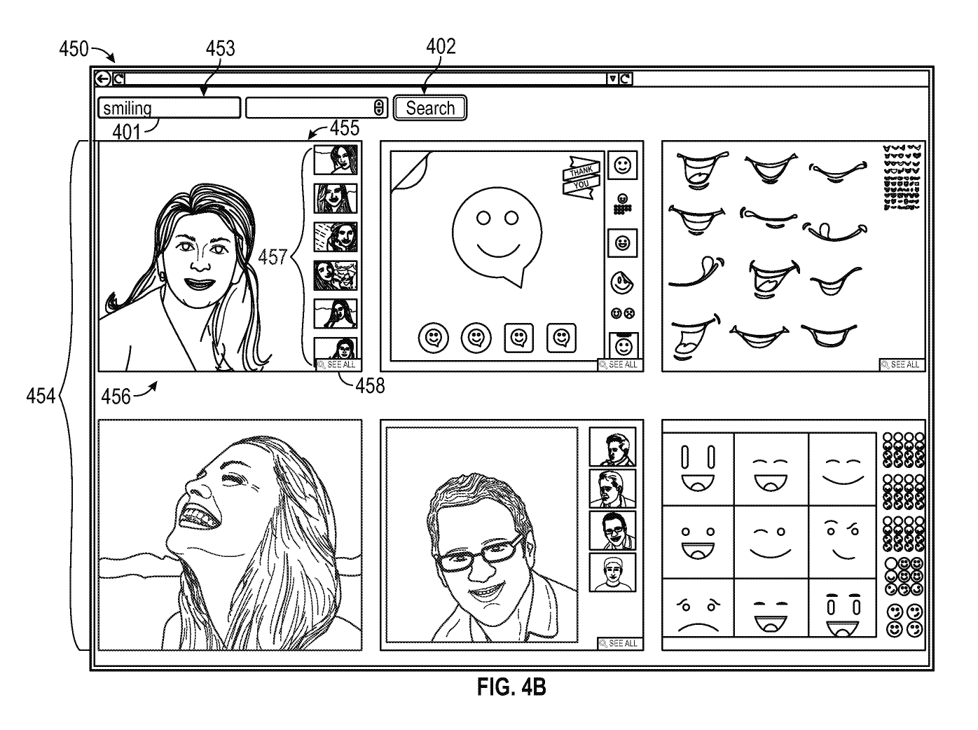

After the identifiers for the images responsive to the search query “beer” are grouped into clusters based on the visual similarity between their corresponding dense image vectors in step 304, then in step 305 the images are provided for display in a web browser or other application on the mobile client 110 of the user that submitted the search query. FIG. 4A provides an example illustration 400 of image media files responsive to the search query “beer” as displayed to the user. The example illustration includes an identification of the search query “beer” 403 entered into a search input field 401 and submitted by the user for processing using a search submission button 402. The groups of images identified as most responsive to the search query “beer” are displayed in a search results region 404. The most prominent group of images 405 includes a single, representative large thumbnail 406 of collected clipart, and additional but smaller thumbnails 407 of images in the group 405 that are visually similar to the representative large thumbnail 406. The user can view more images in the group 405 by selecting a “see all” button 408. Thus, the most relevant image results are grouped together but further image results can be exposed through the button 408 by permitting the user to click through from the thumbnails displayed for the group 405 to find more images in the group. Additional groups of images 409, 410, 411, 412, and 413, each group including visually similar images to one another in the same group, are also provided for display. For the sixth group of images 413, the group consists of two visually similar images represented by thumbnails 414 and 415, so no “see all” button is provided for display to show any additional visually similar images in the group 413. The process 300 ends in step 306.

FIG. 4B provides an alternative example illustration 450 of image media files responsive to the search query “smiling” as displayed to the user. The example illustration includes an identification of the search query “smiling” 453 entered into a search input field 401 and submitted by the user for processing using a search submission button 402. The groups of images identified as most responsive to the search query “smiling” are displayed in a search results region 454. The most prominent group of images 455 includes a single, representative large thumbnail 456 of a woman smiling, and additional but smaller thumbnails 407 of images in the group 455 of women smiling that are visually similar to the representative large thumbnail 456. The user can view more images in the group 455 by selecting a “see all” button 458.

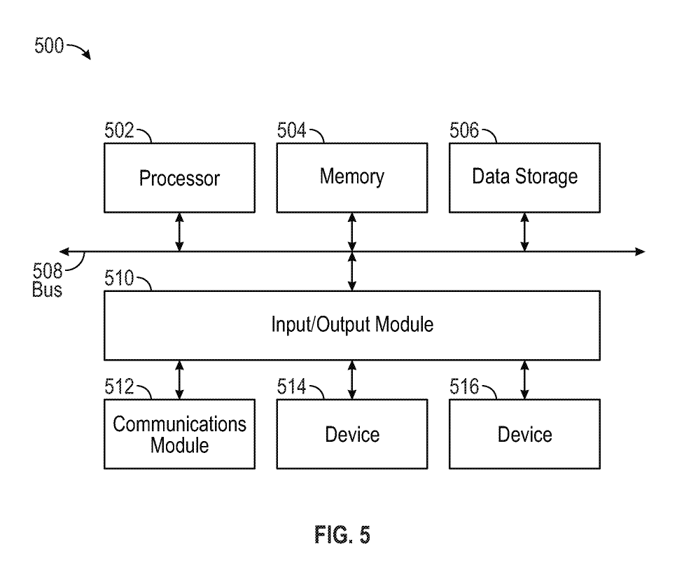

FIG. 5 is a block diagram illustrating an example computer system 500 with which the server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, with languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 (e.g., communications module 238) include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as a CRT (cathode ray tube) or LCD (liquid crystal display) monitor, for displaying information to the user.

According to one aspect of the present disclosure, the server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for analyzing data files to identify similar files to group for display within a limited visual space of a graphical user interface, the method comprising:
receiving a search query for a collection of media files;
identifying a subset of the media files from the collection that is responsive to the search query;
grouping the subset of the media files into a plurality of groups based on their visual similarity, wherein the visual similarity of each media file in the subset of media files is determined using an image vector corresponding to each media file; and
providing the subset of the media files for display in their respective groups.

2. The method of claim 1, wherein each media file in the collection of media files has an associated unique index value mapping each media file to a corresponding dense image vector for the media file capturing the visual nature of the media file.

3. The method of claim 2, wherein the plurality of groups are clusters, and wherein the subset of the media files are grouped into a predetermined number of the clusters using a k means clustering algorithm.

4. The method of claim 3, wherein grouping the subset of media files into the predetermined number of the clusters using the k means clustering algorithm comprises applying a cosine similarity algorithm to the dense image vectors corresponding to the subset of media files.

5. The method of claim 4, further comprising normalizing each of the dense image vectors prior to applying the cosine similarity algorithm to each of the dense image vectors.

6. The method of claim 2, wherein the subset of the media files is grouped into the plurality of groups using thresholding, the thresholding comprising assigning a first media file from the subset of media files to a cluster for the first media file, and for each of the remaining media files in the subset of media files calculating a distance between the corresponding media file and an existing cluster centroid, and if the calculated distance is greater than a predefined threshold, adding the corresponding media file to the existing cluster centroid, otherwise adding the corresponding media file to a new cluster centroid.

7. The method of claim 1, wherein providing the subset of the media files for display in their respective groups comprises, for each group to be displayed, displaying a first media file in the group at a first size, and displaying at least one other file in the group at a second size smaller than the first size.

8. The method of claim 1, wherein providing the subset of the media files for display in their respective groups comprises, for each media file in a group to be displayed, displaying each of the displayed media files in the group at equal sizes.

9. The method of claim 1, wherein providing the subset of the media files for display in their respective groups comprises, for media files not displayed in a displayed group of media files, providing an interface for a user to select additional media files from the displayed group to be displayed.

10. The method of claim 1, wherein the respective groups are ordered according to a responsiveness value to the search query of the most responsive media file in the respective group, or wherein the respective groups are ordered according to an average of the responsiveness values to the search query of each of the media files in the respective group.

11. A system for analyzing data files to identify similar files to group for display within a limited visual space of a graphical user interface, the system comprising:
a memory comprising instructions; and
a processor configured to execute the instructions to:
receive a search query for a collection of media files, each media file in the collection of media files having an associated unique index value mapping each media file to a corresponding dense image vector for the media file capturing the visual nature of the media file;
identify a subset of the media files from the collection that is responsive to the search query;
group the subset of the media files into a plurality of groups based on their visual similarity, wherein the visual similarity of each media file in the subset of media files is determined using an image vector corresponding to each media file; and
provide the subset of the media files for display in their respective groups.

12. The system of claim 11, wherein the plurality of groups are clusters, and wherein the subset of the media files are grouped into a predetermined number of the clusters using a k means clustering algorithm.

13. The system of claim 12, wherein grouping the subset of media files into the predetermined number of the clusters using the k means clustering algorithm comprises applying a cosine similarity algorithm to the dense image vectors corresponding to the subset of media files.

14. The system of claim 13, wherein the processor is further configured to normalize each of the dense image vectors prior to applying the cosine similarity algorithm to each of the dense image vectors.

15. The system of claim 11, wherein the subset of the media files is grouped into the plurality of groups using thresholding, the thresholding comprising assigning a first media file from the subset of media files to a cluster for the first media file, and for each of the remaining media files in the subset of media files calculating a distance between the corresponding media file and an existing cluster centroid, and if the calculated distance is greater than a predefined threshold, adding the corresponding media file to the existing cluster centroid, otherwise adding the corresponding media file to a new cluster centroid.

16. The system of claim 11, wherein providing the subset of the media files for display in their respective groups comprises, for each group to be displayed, displaying a first media file in the group at a first size, and displaying at least one other file in the group at a second size smaller than the first size.

17. The system of claim 11, wherein providing the subset of the media files for display in their respective groups comprises, for each media file in a group to be displayed, displaying each of the displayed media files in the group at equal sizes.

18. The system of claim 11, wherein providing the subset of the media files for display in their respective groups comprises, for media files not displayed in a displayed group of media files, providing an interface for a user to select additional media files from the displayed group to be displayed.

19. The system of claim 11, wherein the respective groups are ordered according to a responsiveness value to the search query of the most responsive media file in the respective group, or wherein the respective groups are ordered according to an average of the responsiveness values to the search query of each of the media files in the respective group.

20. A non-transitory machine-readable storage medium comprising machine-readable instructions for causing a processor to execute a method for analyzing data files to identify similar files to group for display within a limited visual space of a graphical user interface, the method comprising:
receiving a search query for a collection of media files, each media file in the collection of media files having an associated unique index value mapping each media file to a corresponding dense image vector for the media file capturing the visual nature of the media file;
identifying a subset of the media files from the collection that is responsive to the search query;
clustering the subset of the media files into predetermined number of groups based on their visual similarity using a k means clustering algorithm by applying a cosine similarity algorithm to the dense image vectors corresponding to the subset of media files; and
providing the subset of the media files for display in their respective groups ordered according to a responsiveness value to the search query of the most responsive media file in the respective group, or ordered according to an average of the responsiveness values to the search query of each of the media files in the respective group,
wherein providing the subset of the media files for display in their respective groups comprises, for each group to be displayed, displaying a first media file in the group at a first size, and displaying at least one other file in the group at a second size smaller than the first size, or for each media file in a group to be displayed, displaying each of the displayed media files in the group at equal sizes, and for media files not displayed in a displayed group of media files, providing an interface for a user to select additional media files from the displayed group to be displayed.
